(19) United States
(12) Patent Application Publication
(10) Pub. No.: US 2026/0161373 A1
(43) Pub. Date: Jun. 11, 2026

(54) DISTRIBUTED SYSTEM FEATURE MANAGEMENT

(71) Applicant: Salesforce, Inc., San Francisco, CA (US)

(72) Inventors: Senthilkumar Narayanasamy, San Jose, CA (US); Venkateswararao Jujjuri, Beaverton, OR (US); Kaushal Mittal, Mountain House, CA (US)

(21) Appl. No.: 19/039,035

(22) Filed: Jan. 28, 2025

Related U.S. Application Data
(60) Provisional application No. 63/728,832, filed on Dec. 6, 2024.

(51) Int. Cl. G06F 8/41; G06F 8/65; H04L 67/10; H04L 67/51

(52) U.S. Cl. CPC G06F 8/433; H04L 67/10; H04L 67/51; G06F 8/65

(57) ABSTRACT

Techniques for determining which features to utilize in a distributed system with computer services that include a first computer service and a set of dependent computer services. A computer system determines a set of allowed features for a current version of the first computer service, which depends upon the set of dependent computer services. The computer system accesses, from a metadata service, a set of used features indicated as being used by the first computer service. The computer system then creates a maximal feature set for the first computer service from the set of allowed features and the set of used features. After identifying any features in the maximal feature set that are not indicated at the metadata service as having been used by all of the set of dependent computer services, the computer system prevents use of any identified features in the current version of the first computer service.

### CROSS-REFERENCE TO RELATED APPLICATION

The present application claims priority to U.S. Provisional Application No. 63/728,832, entitled “DISTRIBUTED SYSTEM FEATURE MANAGEMENT,” filed Dec. 6, 2024, the disclosure of which is incorporated by reference herein in its entirety.

### BACKGROUND

### Technical Field

This disclosure relates generally to deployment of computer software, and more specifically to deployment of distributed systems with software dependencies.

### Description of the Related Art

Distributed computer services with dependencies refer to a network of interconnected services that operate across multiple computing nodes, where the execution of one service may rely on the availability and performance of other services. This architecture enhances scalability and resilience, allowing applications to handle varying loads efficiently. Managing these dependencies, however, introduces complexities, as the failure or latency in one service can cascade through the system, affecting overall performance and reliability. Properly designed, though, distributed services with dependencies can offer significant advantages in flexibility, resource utilization, and responsiveness, making them essential in modern cloud-based environments and microservices architectures.

Rapid release software methodology, often associated with agile development practices, emphasizes the quick and iterative delivery of software features and updates. This approach allows development teams to break down large projects into smaller, manageable increments to minimize the risk of significant failures and enhance product quality.

### BRIEF DESCRIPTION OF THE DRAWINGS

FIG. 1 is a block diagram of one embodiment of a system for distributed feature management.

FIG. 2 is a block diagram of one embodiment of a computer service having multiple features.

FIG. 3 is a block diagram of a cluster of storage nodes implementing a computer service.

FIG. 4 is a block diagram depicting operations involved in feature tracking for server computer services.

FIG. 5 is a block diagram depicting operations involved in feature tracking for client computer services.

FIGS. 6A-B illustrate examples of client and server upgrades.

FIG. 7 is a block diagram of one embodiment of a distributed system with multiple levels of dependencies.

FIG. 8 is a block diagram of one embodiment of a distributed storage system using techniques previously described in this disclosure.

FIG. 9 is a flow diagram of one embodiment of a method for distributed feature management.

### DETAILED DESCRIPTION

With frequent releases involved in rapid release methodology, there is a risk of introducing bugs or regressions. This risk is heightened in the context of adding new features to a distributed system that includes multiple services that exchange data. Thus, when one of these services is updated—for example, modifying the format of data being exchanged—it can break compatibility with dependent services that use this data. Accordingly, it is important to make sure that cross-service compatibility is preserved during the addition of new features.

Enforcing a strict deployment order between related services is often impractical, particularly with a rapid release methodology. Accordingly, it is typical to employ a loosely coupled paradigm in which services have independent upgrade cycles and thus can be upgraded in any order. Maintaining compatibility between services in such a scenario can be challenging, especially with interface changes or persistent data format changes. For example, if a service S1 that is dependent on services S2 and S3 is upgraded before S2/S3, S1 may run with new features, while S2 and S3 might not be compatible with this new version. Additionally, most services use rolling updates where instances are upgraded one by one, resulting in a mix of versions running concurrently while still serving requests.

In addition to independent upgrades of services in a distributed system, the need to downgrade specific services may also arise. Validating compatibility during downgrades, especially for services lower in the dependency hierarchy, can be a significant challenge.

The present inventors recognize the challenges in implementing changes in a distributed system, particularly in certain deployment environments such as one that uses a rapid release methodology. The present inventors also realize that deployment environments with frequent feature releases require a robust rollback mechanism for the distributed system to rollback to older, more stable versions. The present application proposes a decentralized feature-based service management protocol that helps ensure that the distributed system does not operate such that constituent services have incompatible feature sets, and that there are compatible feature sets during downgrades.

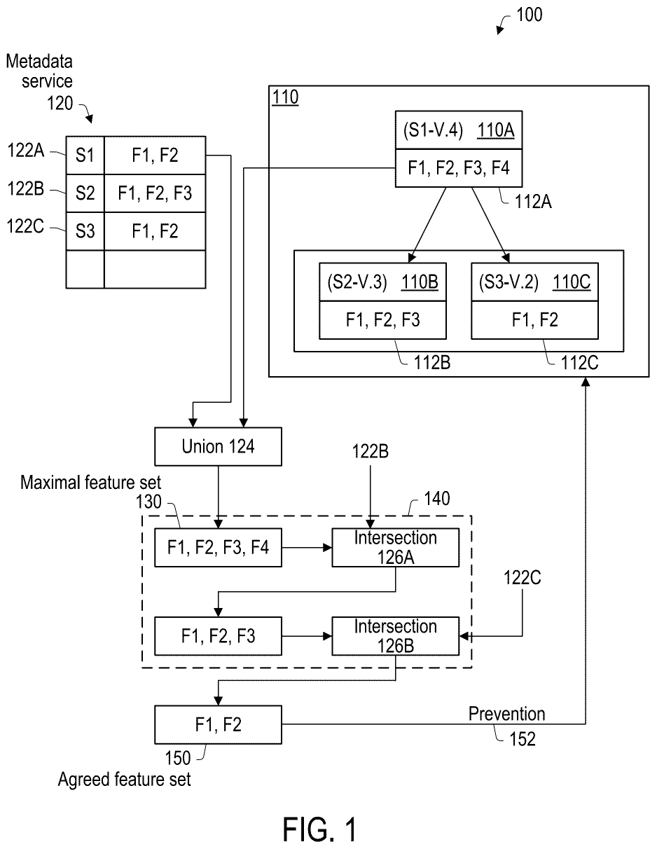

This protocol is illustrated in FIG. 1, which is a block diagram of one embodiment of a system that performs distributed feature management. As depicted, computer system 100 includes a plurality of computer services 110A-C, metadata service 120, and logic that outputs an agreed feature set 150 from a maximal feature set 130. Agreed feature set 150 can be used to ensure (e.g., via a prevention operation 152) that computer service 110A operates with a set of features that are supported by those services on which computer service 110A directly depends (i.e., computer services 110B-C).

In the example shown in FIG. 1, computer services 110 are all at different versions. Computer service 110A (also referred to as S1) is at version 4, while computer services 110B-C (S2-S3), on which computer service 110A depends, are at versions 3 and 2, respectively. A computer service depends on another computer if the former relies on functionality from the latter. For example, computer service 110A might be a proxy service that provides connectivity to a database, while computer service 110B is a log store service executable to store database logs and computer service 110C is a data store service executable to access data extents. Note that services 110B-C may in turn depend on other services, but that scenario is not shown in FIG. 1 for simplicity. Note further that computer services 110B-C can be said to be direct dependencies of computer service 110A because there are no intervening services between services 110A and 110B and between services 110A and 110C. Finally, services 110A-C are independently upgradable and downgradable relative to one another in various embodiments.

As depicted, a given version of a computer service 110 has a set of features. As used herein, a “feature” in a computer service is some piece of functionality, such as functionality that affects the exchange of data or interaction with other services. A feature in a given computer service can have various statuses associated with it at different times. For example, a feature may be indicated as in development (“dev”), subsequently indicated as “available,” and then finally indicated as “allowed.” Development features are by default disabled and cannot be enabled in the event of a downgrade. Available features are fully tested and by default disabled. But these features can be enabled in the event of a downgrade. Allowed features are features that are tested and that the service would utilize were there not any dependencies with other services. The status of features may be indicated as part of the executable of the service itself. As depicted, computer service 110A has allowed features 112A (F1, F2, F3, and F4). Computer services 110B-C, on the other hand, have allowed features 112B (F1, F2, F3) and 112C (F1, F2), respectively.

Notably, the fact that a feature of a service is indicated as “allowed” does not mean that this feature has actually been used by the service. Indeed, the approach outlined in the present disclosure is designed to ensure that a computer service that is dependent on other computer services uses a set of features that are supported by those dependent services before actually using any of those features. This approach advantageously avoids incompatibilities between feature-use of services in a distributed system.

When a computer service 110A starts up or is initialized, it is executable to determine its allowed features, such as by reading from a feature.json file included in the binary executable of the services. For example, service 110A has allowed features F1 to F4. The “used” features of the service are maintained in a shared storage such as metadata service 120, which is available to each of services 110.

Computer service 110A is further executable to access metadata service 120 to obtain its current globally used feature set (GUFS, or used features) 122A, which in this case is features F1 and F2. A union operation 124 is performed to determine a maximal feature set 130 for computer service 110A, which is the greatest possible number of features that might ultimately be agreed upon for computer service 110A. As shown, maximal feature set 130 in this case is F1 to F4. This difference between allowed features 112A and used features 122A stems from the fact that computer service 110A cannot use a feature until that feature is used by all of its dependent services (here services 110B-C). FIG. 1 thus illustrates a scenario in which computer service 110A allows features F3 and F4, but those features have not been supported by its dependent services.

Note the use of union operation 124 to compute maximal feature set 130 for computer service 110A. Used features 122A do not account for features that may have been added via an upgrade to computer service 110A (e.g., features F3 and F4). But allowed features 112A alone are not sufficient either. Consider a scenario in which computer service 110A has been downgraded such that only feature F1 is allowed (F2 is in available state). Using allowed features 112 alone would result in an incorrect maximal feature set. In this case, the union of 112A and 122A will produce a maximal feature set 130 that includes features F1 and F2. Because using only allowed features 112A or only used features 122A does not result in the proper maximal feature set 130, a union operation between allowed features 112A and used features 122A is utilized.

Dependent services 110B-C will also compute their used features by the unions of 112B/C and 122B/C, respectively. A process is then undertaken to compute agreed feature set 150 from maximal feature set 130. This is performed by the intersection of maximal feature set 130 with each of used feature sets 122B-C for the dependent services. As depicted, an intersection operation 126A is performed on maximal feature set 130 and used feature set 122B for dependent service 112B, which results in F1, F2, and F3. This result is provided as an input to another intersection operation 126B with used feature set 122C for dependent service, which results in agreed feature set 150 (F1 and F2). In this manner, features F1 and F2 are determined to be common to all of computer services 110A-C.

Computing agreed feature set 150 may include, for a given one of the of the set of dependent computer services 110B-C, performing a routine that includes accessing, from metadata service 120, a set of used features that have been indicated as being used by the given dependent computer service. Any feature in the maximal feature set not present in the set of used features for the given dependent computer service is then removed, creating an updated maximal feature set. The routine is then repeated for remaining dependent computer services 110B-C, with the final updated maximal feature set becoming agreed feature set 150.

A prevention operation 152 may then be performed on computer services 110 to prevent those features that are in allowed features sets 112A but are not in agreed feature set 150. Thus, features F3 and F4 are prevented from being used by computer service 110A. Note that prevention operation 152 may constitute not enabling features F3 and F4 (e.g., by not setting configuration toggle switches, etc.) in some embodiments. In other embodiments, prevention operation 152 could constitute disabling features F3 and F4 if those features are enabled by default.

Note that feature F3 is not prevented from being used by computer service 110B, however. This is true as long as computer service 110B has no dependent services or if those dependent services are using F3. In such cases, computer service 110B can use feature F3 independent of whether computer service 110A can use it.

Agreed feature set 150 is thus the feature set that computer service 110A is allowed to use. Dependent computer services 110B-C are not aware of what features of being used by computer service 110A. When computer services 110B-C start up, they perform the same process that computer service 110A does, in order to determine, based on any dependencies, what features they are permitted to use.

In various embodiments, if it is determined that a new feature included in the set of allowed features for a current version of computer service 110A (e.g., features F3 and F4) is used by all dependent computer services, that feature will be added to its set of used features. Consider a different scenario than that shown in FIG. 1, in which features F3 and F4 are used by both computer services 110B-C. In such a case, it would be determined, from the metadata service, that new features included in the set of allowed features for a current version of computer service 110A are used by each of the set of dependent computer services 110B-C. The new features (F3 and F4) would then be added to the set of used features stored at the metadata service for the first service (i.e., included in used features 122A).

This approach provides a decentralized way to perform feature management. Each service 110 storing its used features in metadata service 120 allows computations to be performed that determine the maximal common set of used features between a plurality of interdependent services. Further, ensuring that a particular feature is “available” for a downgrade window of N versions prior to that feature being designated as “allowed” provides backward compatibility. For example, if a particular service has used a feature F3 and that service has to be downgraded, the previous N versions of that service are available for downgrade, since those versions are guaranteed to have at least an “available” version of the particular service.

It is noted that this process of feature discovery is recursive. Although not shown, when computer services 110B-C are themselves dependent on other computer services (not pictured), the same process described with respect to computer service 110A may be used by computer services 110B-C determine respective sets of used features in the metadata service based on any computer services on which they directly depend. As has been explained, “directly depend” means that there is no intervening level of dependency-computer service 110A is directly dependent on computer services 110B-C, but is not directly dependent, for example, on any services that computer services 110B-C directly depend on.

Note that in some embodiments, a given one of dependent computer services 110B-C may be implemented in a distributed fashion on a plurality of computing nodes. In such cases, the given dependent computer service may be executable to update its set of used features at metadata service 120 after all of the plurality of computing nodes have completed an upgrade to a new version of the given dependent computer service. Thus, if computer service 110B is being updated to a new version that includes feature F3, used features 122B at metadata service 120 will be updated only after all of the plurality of computing nodes are updated to the new version. In one possible implementation, one of the plurality of computing nodes may be selected as an “auditor node” so that it is executable to update the set of used features for the dependent computer service upon completing the upgrade. The auditor node may also be executable to enable any new features in the new version of the dependent computer service on each of the plurality of computing nodes.

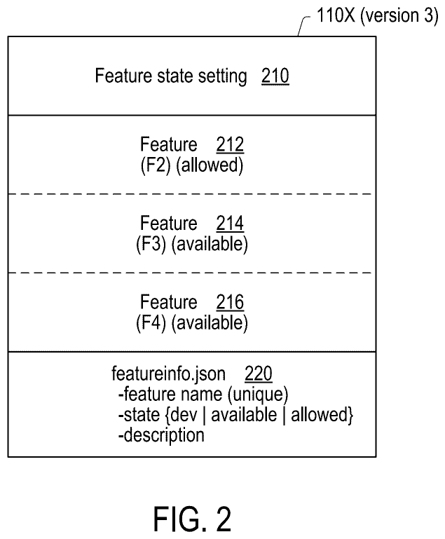

FIG. 2 is a block diagram of one embodiment of a computer service having multiple features. As shown, computer service 110X includes feature state settings 210, features 212, 214, and 216. In this example, computer service 110X is at version 3.

As shown, computer service 110X further includes feature information portion 220, which in one embodiment is located in a portion of its binary referred to as featureinfo.json. Feature information portion 220 indicates information about features that are currently included in that version of the service. This information may include, in one embodiment:
featureinfo.json
FEATURE_NAME, STATE, DESCRIPTION
   FEATURE_NAME: A clear and unique identifier for the feature within the system, showing how it connects to other services.
   STATE: {DEV|AVAILABLE|ALLOWED}
   Description: one liner sentence in double quotes describing the feature/change.

As noted, possible states include:
DEV: Optional state, used for features being developed over several iterations.
AVAILABLE: When a feature is ready, fully tested.
ALLOWED: Once the feature has been available for an entire downgrade window (N-releases, 2 or 4), its state can be changed to ALLOWED.

Features 212, 214, and 216 correspond, in this example, to features F2, F3, and F4, respectively. Feature F2 (212) is in the “allowed” state, while features F3 and F4 (214, 216) are in the “available” state. To effectuate these states, feature state settings 210 will cause feature F2 to be enabled in version 3, but cause features F3-F4 to be disabled. In a subsequent version of computer service 110X (version 4 for example), feature F3 might be allowed while feature F4 might remain in the available state. If the downgrade window N=2, feature F4 would become allowed in version 5 of computer service 110X. As has been noted, in some embodiments, a plurality of computer services may each support a downgrade window of N versions for a particular feature indicated as being used by the distributed system, guaranteeing (via downgrading-checking code) that the particular feature will be available when a constituent service of the distributed system is downgraded to one of its previous N versions. See, for example, U.S. application Ser. No. 18/313,067, entitled “DOWNGRADING DATABASE SOFTWARE” and assigned to present assignee, which is incorporated by reference herein in its entirety. A downgrade may be denied if downgrade compatibility cannot be guaranteed.

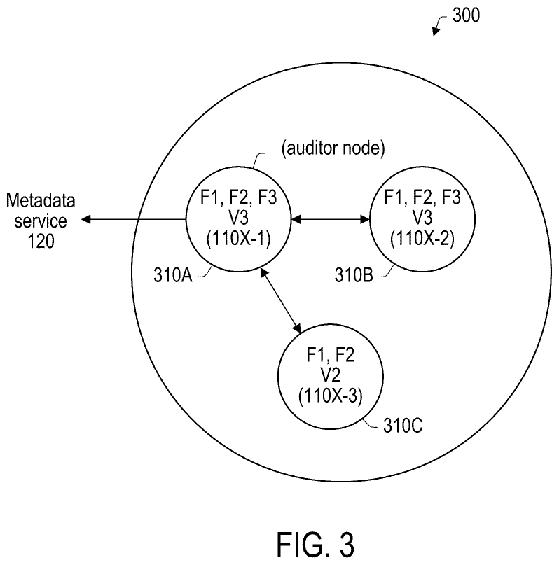

FIG. 3 is a block diagram of a cluster of storage nodes implementing a computer service. As depicted, cluster 300 includes three nodes, 310A-C, each implementing an instance of computer service 110X. Node 310A is currently implementing instance 110X-1, while nodes 310B-C are implementing instances 110X-2 and 110X-3, respectively. Node 310A is designated as an auditor node and is in communication with metadata service 120. A “node,” as used herein, is a set of hardware computing resources (e.g., processor and memory) allocated to perform computer service 110X.

Cluster 300 can be used to provide redundancy and availability for computer service 110X. But in order to maintain consistency during an upgrade of computer service 110X (since all nodes cannot always be updated simultaneously), the set of features indicated as being used on metadata service 120 will be updated only after all of the plurality of computing nodes have completed an upgrade to a new version of the given dependent computer service. To this end, an auditor node may be selected from the plurality of computing nodes in the cluster (here, node 310A). The auditor node is executable to update the set of used features for computer service 110X upon completing the upgrade, meaning that all nodes have completed the upgrade. At that point, any new features in the new version of computer service 110X may be enabled on the plurality of computing nodes.

In the illustrated example, nodes 310A and 310B are currently running V3 of computer service 110X. Node 310C, however, is running V2. Accordingly, because the upgrade to V3 is not yet complete for cluster 300, computer service 110X will remain at V2. Accordingly, feature F3 will not be enabled at nodes 310A-B until such time as the upgrade to V3 completes.

The auditor node can be selected from among the plurality of computing nodes in cluster 300 by any suitable means. The auditor node will monitor the state of the other computing nodes and when they are all running the same version, the auditor node will communicate to metadata service 120 that features F1-F3 are now all present in all binaries of computer service 110X that are operating within cluster 300.

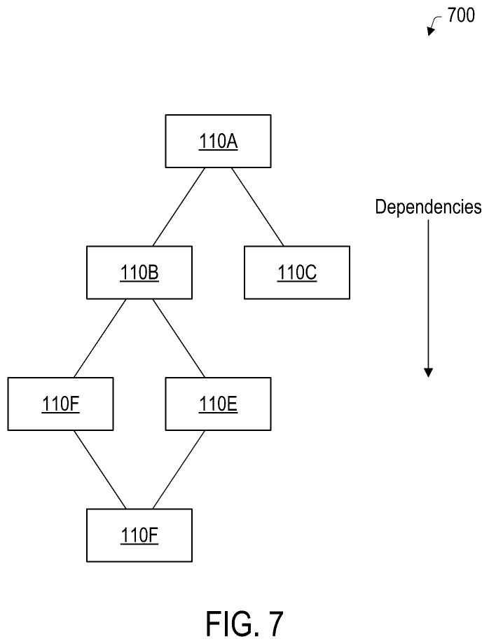

The next two sections distinguish between “client” and “server” computer services. As used herein, a client computer service is one that depends upon one or more other computer services, which are referred to as “server” computer services to that client computer service. In the context of the embodiment of FIG. 1, computer service 110A is a client computer service and computer services 110B-C are server computer services to service 110A. Note that computer services 110B-C can also be client computer services if they depend on other computer services, as will be discussed below with respect to FIG. 7. Accordingly, a given computer service may act as both a client and a server with respect to other computer services.

### Server Feature Tracking

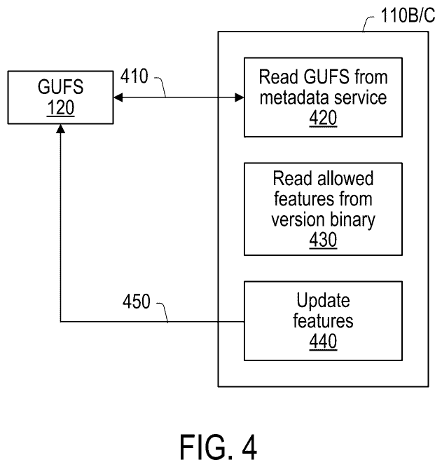

FIG. 4 is a block diagram depicting operations involved in feature tracking for server computer services such as computer service 110B or 110C. As depicted, these operations utilize metadata service 120 and the computer service 110B/C itself. (The notation 110B/C is intended that the same process occurs for both computer service 110B and 110C.) Note that computer service 110B/C, in some embodiments, may be implemented on a cluster of storage nodes as detailed in FIG. 3.

In general, when a computer service starts up, that service determines which features it is allowed to use (e.g., as indicated in its binary). The service then determines a list of USED features, which may be stored in a location such as metadata service 120. The specification location within metadata service may be defined by a unique code such as a cluster ID (CLUUID) in some implementations (e.g., in location defined by a path such as/dbstore/<CLUUID/usedfeatureset). The USED features of the server cluster can be maintained in metadata service 120 as a GUFS (Global Used Feature Set). The GUFS will be used by a software update pipeline and the client to determine which features are allowed in the storage cluster.

In operation 420, an initialization (init) process of computer service 110B/C performs a read operation 410 to retrieve the GUFS from metadata service 120. Note that a GUFS might not be stored in metadata service 120 if the cluster for service 110B/C is new or if features are not being tracked. In such cases, the init process will start with an empty set. In operation 430, computer service 110B/C will read the ALLOWED features in its binary (e.g., featureinfo.json). In 440, a new GUFS is computed for computer service 110B/C by combining the current GUFS at metadata service 120 with the ALLOWED features in the binary. This is an additive operation if the current GUFS is a proper subset of the newly computed set, and the GUFS should be updated with the newly computed set via update operation 450.

In various embodiments, the GUFS for server computer services should be updated via update operation 450 when all nodes in the clusters are running at the same version. As previously explained, this can be achieved by using an auditor node. In order to monitor software update (downgrade/upgrade) activities, two possible options are:
1. Using KUBERNETES APIs to get the statefulset rolling update status. KUBERNETES, as is understood in the art, is a deployment system that manages containerized applications (containers). KUBERNETES may be used to deploy the nodes/containers in a cluster. KUBERNETES can maintain status metadata about the deployment (or state of the cluster), which can be used to determine if KUBERNETES is done. If KUBERNETES is done, then all the nodes have been updated.
2. When a service boots up in some embodiments, it creates a cookie that contains various pieces of information about the service, such as its version, its location, etc. The cookie may be stored by metadata service 120 such that service 120 includes cookies for all nodes in a cluster. The auditor node can look at these cookies and see if all the nodes in the cluster are at the same version. If they are, then the upgrade process is done.

The downgrade impact change code path can check feature state using the built-in function provided by the framework. If it is in the “ALLOWED” state, it can continue the execution of impactable change.

Consider the following scenario, in which there is an issue with an upgrade that necessitated a downgrade before completion, meaning that GUFS would not have been updated:
A feature is introduced in versions v3, v4, and becomes fully usable in v5.
The entire cluster is on v4, and an upgrade to v5 is in progress.
Node-1 in the cluster upgrades to v5 and applies changes that could impact a downgrade.
But before GUFS is updated, the v5 upgrade is aborted due to a critical issue discovered during the rolling upgrade.
   At this point, data is written by the v5 Node-1, but GUFS does not record the new feature. The cluster is then downgraded back to v4, and subsequently to v3. This is still safe because these versions can read the data written by v5.

But an issue arises if there is an attempt to downgrade to v2. Since the new feature introduced in v5 was never recorded in GUFS, the downgrade check does not block it, and the downgrade proceeds. Problematically, the v2 server cannot read the data written by the v5 Node-1 (also referred to as a “bookie”). This scenario can be addressed with the following approach:
1. Server-only features will have both a feature state and configuration setting.
2. When the feature is marked as “Allowed” in a version, the configuration will remain disabled.
3. After a downgrade-safe window (e.g., 2 or 4 releases), the configuration is enabled. Until then, with the feature marked as “Allowed” and configuration disabled, individual server nodes won't make any changes that could impact downgrades.

### Client Feature Tracking

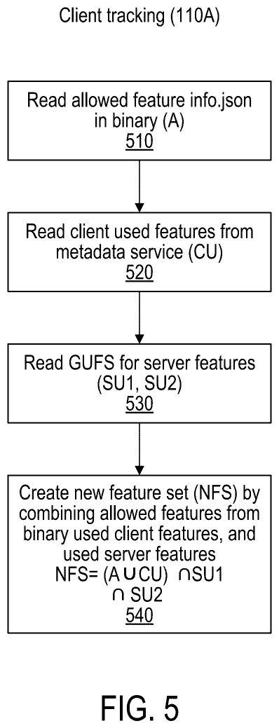

FIG. 5 is a block diagram depicting operations involved in feature tracking for client computer services such as computer service 110A. Similar to the handling of things on the server-side, the Used Feature Set for the client is maintained in metadata service 120 (e.g., under the CLUUID namespace for the client). To facilitate feature tracking, a client can perform various operations during the boot-up process as outlined below.

In 510, client computer service 110A reads featureinfo.json in its binary to determine what features are allowed in its current version (A). In 520, service 110A then reads the current version of its used features (CU) as stored on metadata service 120 (e.g., under namespace for the client). Next, in 530, the boot-up process reads the GUFS for the server computer services on which computer service 110A directly depends (which can be generically referred to as SU1 and SU2, specific examples of which are computer services 110B and 110C).

In 540, the boot-up process then creates a new feature set (NFS) by combining the allowed features from featureinfo.json, the client GUFS, and the server GUFS. The following formula is used to compute the NFS in the case where there are two directly dependent server services:
NFS=(Client featureinfo.json (Allowed)∪Client-GUFS)∩Directly
Dependent Server Service 1-GUFS∩Directly Dependent Server Service 2-GUFS.
   One advantage of this approach is that it combines inherent capabilities with the features offered by connected storage clusters, reflecting the entire service hierarchy dependencies. This new feature set ensures compatibility across the entire stack for operations like upgrades or downgrades, eliminating the need to validate individual services.

Concurrent updates may be avoided by the optimistic concurrent (Compare and Swap) control offered by metadata services such as ZOOKEEPER since multiple proxies may attempt to update at the same time. The downgrade impacting code can check feature state. If it is in the “Allowed” state, it can continue the execution. Note that, in some embodiments, every client evaluates and updates its used features set at metadata service 120 at boot time irrespective of if it is an upgrade or restart.

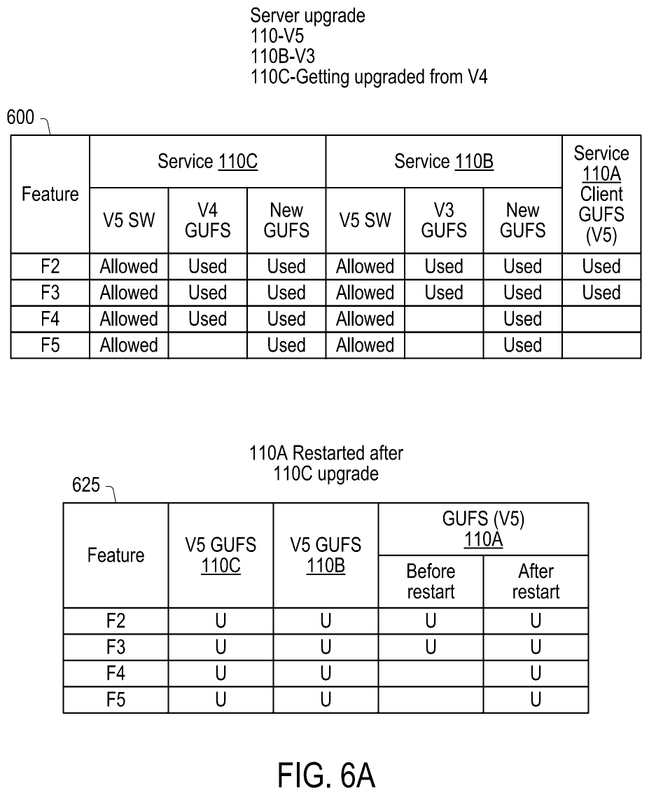

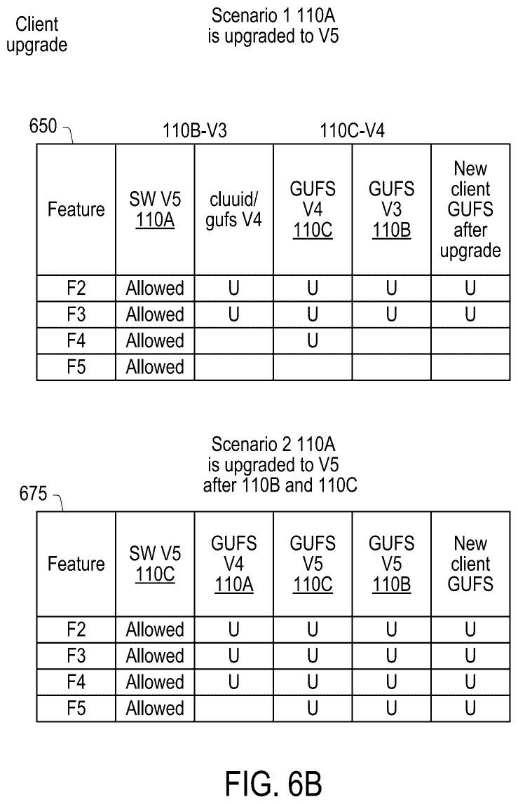

FIG. 6A includes two examples illustrating a server upgrade according to the present disclosure. In example 600, computer service 110C that is a server relative to computer service 110A is being upgraded from V4 to V5, while computer service 110B is getting upgraded from V3 to V5. Computer service 110A is already at V5.

Computer service 110C's binary indicates features F2-F5 as allowed, while the GUFS for V4 (before the upgrade) shows F2-F4 as being used. The union of these two results in a GUFS of F2-F5. Similarly, computer service 110B's binary indicates features F2-F5 as being allowed, while the GUFS for V3 (before the upgrade) shows F2-F3 as being used. The union of these two results in a GUFS of F2-F5.

In this embodiment, the upgrades of computer services 110B-C are cluster upgrades because both services are implemented on a cluster of storage nodes as explained with respect to FIG. 3. Note that the newly computed GUFS is always a superset of the current GUFS and hence any feature “used” in the cluster will continue to be in the same state. As shown in example 600, although features F4 and F5 are allowed by the storage clusters after the upgrade, computer service 110A (the client in this scenario) will not use these features till it is restarted (as shown by rightmost column). Example 625 illustrates that after restart, computer service 110A will have a GUFS indicating that features F2-F5 are used.

FIG. 6B illustrates two examples of client upgrade scenarios for computer service 110A. Note that the software update pipeline for computer service 110A in this embodiment does not need to check and enforce the feature compatibility. Instead, computer service 110A's runtime component can compute a new feature set by combining allowed features in its binary, its used features indicated at the metadata service, and the used features indicated for 110B-C at the metadata service.

In example 650, computer service 110A is getting upgraded to V5, where F5 is indicated as allowed in V5. As seen in the third column, the metadata service indicates that only features F2-F3 are used in V4 for computer service 110A. Computer service 110B is at V3, while computer service 110C is at V4. Because computer service 110A depends on services 110B-C, the GUFS for computer service 110A will indicate that features F2-F3 are to be used by computer service 110A after the upgrade. In other words, computer service 110A's feature list at the metadata server does not change when it is upgraded since computer service 110B and 110C do not both use F4 and F5.

In contrast, example 675 illustrates the GUFS for computer service 110A being upgraded to V5 if computer services 110B-C have already been upgraded to V5. The union of the features of computer service 110A shown in columns two and three of example 675 is features F2-F5. As can be seen in the fourth and fifth columns of example 675, both computer services have a GUFS that includes F2-F5. Accordingly, the rightmost column indicates that computer service 110A will have a GUFS that includes features F2-F5.

### Downgrades

With respect to downgrades, the software pipeline should verify that the features in the target software version are compatible with those in the running system before initiating the downgrade. This process may involve extracting the available/allowed features from the target binary and comparing them with the Used Feature Set in the current system. If any feature in the Used Feature Set is missing in the target version, the downgrade will be disallowed.

In the case of a need to downgrade computer service 110B or 110C after all services (e.g., computer service 110A) connected to them have been upgraded and started using the new features, retaining the used feature set across the downgrade will ensure that the entire stack remains compatible when downgrading any services in the hierarchy.

FIG. 7 is a block diagram of one embodiment of a distributed system with multiple levels of dependencies. Distributed system 700 shows computer services 110A with dependencies on computer services 110B-C, as has been previously described. In this embodiment, computer service 110C has no dependencies, but computer service 110B is directly dependent on computer services 110E-F, which in turn are both directly dependent on computer service 110G.

As noted, computer service 110A performs an initialization process to interact with metadata service 120 (not pictured here) to determine a maximal feature set and then removing, from the maximal feature set, any features that are not indicated at the metadata service as having been used by all of the set of computer services that directly depend on service 110 (i.e., services 110B-C), thus creating a final feature set. Additionally, a similar initialization process is performed by other services in system 700. While computer services 110C and 110F have no such dependencies, services 110B, and 110E-F do.

Accordingly, service 110B will interact with metadata service 120 to determine a feature set that ensures compatibility with services 110D-E, which will in turn affect the feature set that will be shared by services 110A-C. Services 110D-E perform a similar procedure with respect to service 110F. In this manner, services that are lower in the dependency hierarchy (e.g., service 110F) will affect what features will be used by those services higher in the dependency hierarchy (e.g., services 110A, 110B, and 110D-F). But in some instances, not all services will share the same features. For example, services 110A-C may all use a feature Fx for their common APIs, but feature Fx may not be used by all other services in system 700.

Accordingly, dependent computer services in a set of dependent computer services that directly depend on a particular computer service may themselves be executable to determine respective sets of used features in the metadata service based on any computer services on which they directly depend.

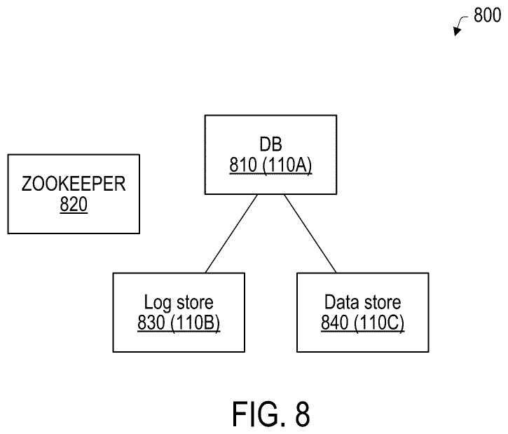

The techniques described herein are applicable to any suitable distributed system having computer services with dependencies. FIG. 8 is a block diagram of one environment in which a distributed system may be implemented. As depicted, distributed storage system 800 includes a database service 810, ZOOKEEPER service 820, log store service 830, and data store service 840. System 800 is distributed because it is built using multiple services that may run on different nodes and different locations (such as different availability zones). Database service 810, in this embodiment, is dependent both on log store service 830 and data store service 840.

Database service 810, in one embodiment, is integrated as part of a database instance, such as an instance of SALESFORCE DB. Various functionalities can be performed by database service 810. Service 810 may, for example, determine availability zones for optimal storage location (based on node capability in those zones in some implementations), creating corresponding metadata entries in metadata service 820 and sending data replicas to the chosen caches or bookies. Service 810 may also be responsible for routing data as appropriate to log store service 830 and data store service 840. In some embodiments, database service 810 may store data extents as a single object that encapsulates the data and its metadata.

In the depicted embodiment, metadata service 820 is implemented using APACHE ZOOKEEPER, which is an open-source distributed coordination service that can be used to provide various types of functionalities for distributed systems. Such services include maintaining configuration information, naming, providing distributed synchronization, and providing group services. These kinds of services are commonly used in some form or another by most distributed applications. ZOOKEEPER is only an exemplary type of a metadata service.

Log store service 830, in one embodiment, is a service designed specifically for storage of database logs with low latency and durability. The logs may be replicated across multiple availability zones in some embodiments. Data store service 840, in one embodiment, may merge features of a cache and a cloud service, and be used for frequently accessed data such as data extents from the database that need to be saved and retrieved quickly. Note that services 830 and 840 may themselves depend on other services (not pictured).

### Example Method

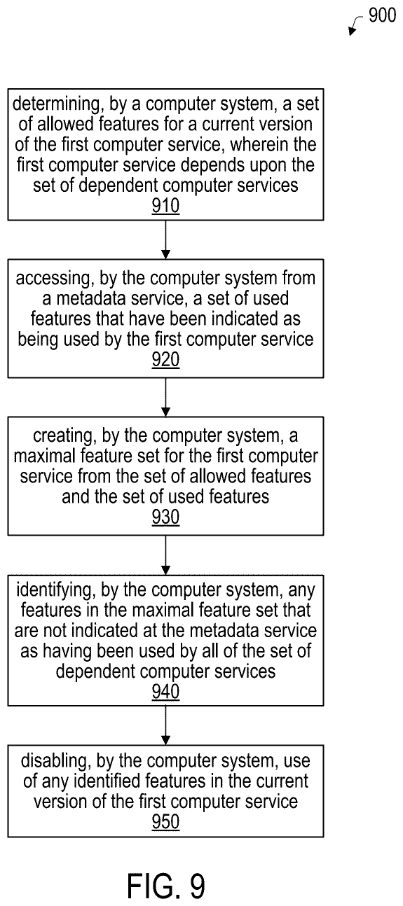

FIG. 9 is a flow diagram of one embodiment of a method 900 for deploying and downgrading database software. Method 900 may be performed, for example, by one or computers implementing an enterprise software deployment environment. Method 900 is a computer-implemented method for determining which features to utilize in a distributed system with a plurality of computer services including a first computer service and a set of dependent computer services, where the plurality of computer services exchange data with one another. Method 900 is susceptible to numerous variations, some of which are noted below. Exemplary reference numerals are provided below to aid in understanding but are not intended to unduly limit method 900.

Method 900 begins at 910, in which a computer system (100) determines a set of allowed features (112A) for a current version of the first computer service (110A), where the first computer service depends upon the set of dependent computer services (110B-C). In some embodiments, the set of allowed features for the current version of the first computer service are determined from information in a binary of the current version.

In 920, the computer system accesses, from a metadata service (120), a set of used features that have been indicated as being used by the first computer service (122A). More generally, each of the plurality of services, including the set of dependent computer services, may update its set of used features at the metadata service by adding a feature now indicated as allowed in its corresponding binary.

Next, in 930, the computer system creates a maximal feature set (130) for the first computer service from the set of allowed features and the set of used features. This may be performed, for example, by a union operation between the set of allowed features and the set of used features. In one scenario, which may correspond to an upgrade of the first computer service, the set of allowed features includes at least one feature not included in the current set of used features. In another scenario, which may correspond to a downgrade of the first computer service, the set of used features includes at least one feature not included in the current set of allowed features.

Method 900 continues in 940, in which the computer system identifies (e.g., via module 140) any features in the maximal feature set that are not indicated at the metadata service as having been used by all of the set of dependent computer services. The identification of 940 may result, for example, in agreed features 150, and my include reading, from the metadata service, a set of used features for a given one of the set of dependent computer services, where the given dependent computer service is executable to update its set of used features upon initialization.

The identifying of 940 may include the computer system, for a given one of the of the set of dependent computer services, performing a routine in which a set of used features that have been indicated as being used by the given dependent computer service are accessed from the metadata service. The routine further includes the computer system removing any feature in the maximal feature set not present in the set of used features for the given dependent computer service, creating an updated maximal feature set. The routine may then be repeated by the computer system for remaining ones of the set of dependent computer services.

Method 900 concludes in 950, in which the computer prevents (152) use of any identified features in the current version of the first computer service. The preventing might include, for example, not setting a configuration switch that would enable the identified features. In other cases, the preventing might include disabling the identified features.

If, on the other hand, the computer system determines from the metadata service that a new feature included in the set of allowed features for a current version of the first computer service is used by each of the set of dependent computer services, the computer system is executable to add the new feature to the set of used features stored at the metadata service for the first service.

Note that the preventing of 950 may be subsequently lifted at some point based on additional upgrades occurring for the first computer service and any dependent services. Thus, a feature Fx that might be prevented from being used in a current version of the first computer service might subsequently be allowed to be used based on additional updates that happened within the distributed system.

Any of the plurality of services in method 900 may be implemented in a distributed fashion on a plurality of computing nodes, with the service being executable to update its set of used features after all of the plurality of computing nodes have completed an upgrade to a new version. In some embodiments, an auditor node selected from the plurality of computing nodes may be executable to update the set of used features for the service upon completing the upgrade, and to enable any new features in the new version of the service on each of the plurality of computing nodes.

Method 900 may be particularly useful in environments in which the plurality of computer services are independently upgradable and downgradable relative to one another. Each of the plurality of computer services may support a downgrade window of N versions for a particular feature indicated as being used by the distributed system. This paradigm can be used to guarantee that the particular feature will be available when a constituent service of the distributed system is downgraded to one of its previous N versions. When a feature is introduced, for example, that feature can be in an “available” state for N versions, before becoming “allowed.” Accordingly, this approach permits the ability to downgrade to any of the previous N versions.

Note that the process in method 900 in which the first computer service determines what features to utilize based on those services on which it directly depends may also be employed in turn by those dependent services. Accordingly, dependent computer services in the set of dependent computer services are executable to determine respective sets of used features in the metadata service based on any computer services on which they directly depend.

The distributed system can encompass any suitable type of functionality. In one embodiment, the distributed system is a database storage system. In one such embodiment, the first computer service is a proxy service that provides connectivity to a database and facilitates database storage operations, and the set of dependent computer services includes a log store service executable to store database logs and a data store service executable to access data extents.

Various techniques described herein may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data centers therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, non-redundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend on other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” be used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method for determining which features to utilize in a distributed system with a plurality of computer services including a first computer service and a set of dependent computer services, the method comprising:
determining, by a computer system, a set of allowed features for a current version of the first computer service, wherein the first computer service depends upon the set of dependent computer services;
accessing, by the computer system from a metadata service, a set of used features that have been indicated as being used by the first computer service;
creating, by the computer system, a maximal feature set for the first computer service from the set of allowed features and the set of used features;
identifying, by the computer system, any features in the maximal feature set that are not indicated at the metadata service as having been used by all of the set of dependent computer services; and
preventing, by the computer system, use of any identified features in the current version of the first computer service; and
wherein the plurality of computer services exchange data with one another.

2. The method of claim 1, wherein the set of allowed features for the current version of the first computer service are determined from information in a binary of the current version.

3. The method of claim 1, wherein the identifying includes reading, from the metadata service, a set of used features for a given one of the set of dependent computer services, wherein the given dependent computer service is executable to update its set of used features upon initialization.

4. The method of claim 3, wherein the given dependent computer service is executable to update its set of used features by adding a feature now indicated as allowed in a binary of the given dependent computer service.

5. The method of claim 1, wherein a given one of the set of dependent computer services is implemented in a distributed fashion on a plurality of computing nodes, and wherein the given dependent computer service is executable to update its set of used features after all of the plurality of computing nodes have completed an upgrade to a new version of the given dependent computer service.

6. The method of claim 5, wherein an auditor node selected from the plurality of computing nodes is executable to update the set of used features for the given dependent computer service upon completing the upgrade, and to enable any new features in the new version of the given dependent computer service on the plurality of computing nodes.

7. The method of claim 1, wherein, for the first computer service, the set of allowed features includes at least one feature not included in the current set of used features, and wherein creating the maximal feature set results from a union of the set of allowed features and the set of used features such that the maximal feature set includes the at least one feature.

8. The method of claim 1, wherein, for the first computer service, the set of used features includes at least one feature not included in the current set of allowed features, and wherein creating the maximal feature set results from a union of the set of allowed features and the set of used features such that the maximal feature set includes the at least one feature.

9. The method of claim 1, wherein the identifying includes:
for a given one of the of the set of dependent computer services, performing a routine that includes:
accessing, by the computer system from the metadata service, a set of used features that have been indicated as being used by the given dependent computer service; and
removing, by the computer system, any feature in the maximal feature set not present in the set of used features for the given dependent computer service, creating an updated maximal feature set; and
repeating the routine for remaining ones of the set of dependent computer services.

10. The method of claim 1, wherein dependent computer services in the set of dependent computer services are executable to determine respective sets of used features in the metadata service based on any computer services on which they directly depend.

11. The method of claim 1, wherein the plurality of computer services each support a downgrade window of N versions for a particular feature indicated as being used by the distributed system, guaranteeing that the particular feature will be available when a constituent service of the distributed system is downgraded to one of its previous N versions.

12. The method of claim 1, wherein the plurality of computer services are independently upgradable and downgradable relative to one another.

13. The method of claim 1, further comprising:
determining, from the metadata service, that a new feature included in the set of allowed features for a current version of the first computer service is used by each of the set of dependent computer services;
adding, based on the determining, the new feature to the set of used features stored at the metadata service for the first service.

14. The method of claim 1, wherein the distributed system is a database storage system, the first computer service is a proxy service that provides connectivity to a database and facilitates database storage operations, and the set of dependent computer services includes a log store service executable to store database logs and a data store service executable to access data extents.

15. A non-transitory, computer-readable storage medium storing program instructions capable of being executed by a computer system to perform operations including:
determining a set of allowed features for a current version of a first computer service, wherein the first computer service depends upon the set of dependent computer services;
accessing, from a metadata service, a set of used features that have been indicated as being used by the first computer service;
creating a maximal feature set for the first computer service from the set of allowed features and the set of used features;
identifying any features in the maximal feature set that are not indicated at the metadata service as having been used by all of the set of dependent computer services; and
preventing use of any identified features in the current version of the first computer service.

16. The non-transitory, computer-readable storage medium of claim 15, wherein the set of allowed features for the current version of the first computer service are determined from information in a binary of the current version.

17. The non-transitory, computer-readable storage medium of claim 15, wherein the identifying includes reading, from the metadata service, a set of used features for a given one of the set of dependent computer services, wherein the given dependent computer service is executable to update its set of used features upon initialization.

18. The non-transitory, computer-readable storage medium of claim 15, wherein the identifying includes:
for a given one of the set of dependent computer services, performing a routine that includes:
accessing, by the computer system from the metadata service, a set of used features that have been indicated as being used by the given dependent computer service; and
removing, by the computer system, any feature in the maximal feature set not present in the set of used features for the given dependent computer service, creating an updated maximal feature set; and
repeating the routine for remaining ones of the set of dependent computer services.

19. A system, comprising:
a first computer system comprising one or more processor circuits and memory storing program instructions executable on the one or more processors circuit to implement a first computer service that depends on a set of dependent computer services that includes a second computer service;
a second computer system configured to implement the second computer service;
a third computer system configured to implement the third computer service;
wherein the program instruction of the first computer system are executable to perform operations including:
determining a set of allowed features for a current version of the first computer service, wherein the first computer service depends upon the set of dependent computer services;
accessing, from a metadata service, a set of used features that have been indicated as being used by the first computer service;
creating a maximal feature set for the first computer service from the set of allowed features and the set of used features;
identifying any features in the maximal feature set that are not indicated at the metadata service as having been used by all of the set of dependent computer services; and
preventing use of any identified features in the current version of the first computer service; and
wherein the first, second, and third computer systems are implemented as computer clusters comprising respective pluralities of computing nodes.

20. The system of claim 19, wherein the system is a database storage system, the first computer service is a proxy service that provides connectivity to a database and facilitates database storage operations, the second computer service is a log store service executable to store database logs, and the third computer service is a data store service executable to access data extents.
